(19) United States
(12) Patent Application Publication
(10) Pub. No.: US 2014/0136279 A1
(43) Pub. Date: May 15, 2014

(54) OneClue Software System and Method

(71) Applicant: Purna Chander Ramini, Bentonville, AR (US)

(72) Inventor: Purna Chander Ramini, Bentonville, AR (US)

(21) Appl. No.: 14/069,999

(22) Filed: Nov. 1, 2013

Related U.S. Application Data
(60) Provisional application No. 61/726,551, filed on Nov. 14, 2012.

(51) Int. Cl. G06Q 30/02

(52) U.S. Cl. CPC G06Q 30/0201
USPC 705/7.29

(57) ABSTRACT

OneClue Software Process & Method captures single clue non-intrusively and use it in analysis to identify the customer (user) experience problem areas.

OneClue Software (System and Method) collects a single clue about the customer experience without making customers to spend additional time in taking survey about their experience, using various ways that are suitable to the customer environment (that they are in). This single clue is used in the analysis to identify the factors that are constituting to the customer experience issues. OneClue Software analytical engine uses various (previously identified) data points (like new changes that are introduced etc.,) that play role, uses its “reduction by elimination” method to create a summary of results that show possible problem areas.

### BACKGROUND

Online applications that are graphical user interface based (either web or native applications) are very prevalent. These applications are used for various reasons including shopping online. Online customers expect excellent shopping experience and do not hesitate to go to other shopping sites if they are not satisfied with their experience. This increased the demand to know and measure the customer experience, using that information to improve. Not doing it could threaten the online site's survival itself. One popular method adopted is to conduct online survey with set of questions and collect the answers for further analysis. One problem with this method is the willingness of the customers to take time from their busy schedule and spend spend time taking the survey. OneClue Software (System and Method) addresses this problem by getting single clue about their experience without making customer to spend additional time. This single clue is used to perform further analysis to alleviate the customer experience problems. Additionally, these online sites are updated constantly with an intention to improve. Measuring the customer acceptance of these changes and their experience is also crucial to the business continuance.

The above describe issue is common even to the physical stores. OneClue (Software System and Method) address this issue by using a panel at the store exists. Customers express their happiness or unhappiness with a single click or a button press. This information is used to conduct further analysis to identify the factors causing the customer experience issues.

Even a presumably small change (by business/company) could deter their existence. It is crucial to identify the customer experience related issues as soon as possible to alleviate further damage to the business or a company.

### SUMMARY

OneClue Software (System and Method) collects a single clue about the customer experience without making customers to spend additional time in taking survey about their experience, using various ways that are suitable to the customer environment (that they are in). This single clue is used in the analysis to identify the factors that are constituting to the customer experience issues. OneClue Software analytical engine uses various (previously identified) data points (like new changes that are introduced etc.,) that play role, uses its “reduction by elimination” method to create a summary of results that show possible problem areas.

### GENERAL DESCRIPTION OF DRAWINGS

FIG. 1: Item 100 is GUI (Graphical User Interface). Item 110 is a pop-up window that provides two options of sign out/log out namely positive/good and negative/bad experience, where both of them will perform sign out action. Item 200 is the data packet containing sign out data and experience indicator, transmitted thru communication medium. Item 300 is a communication medium that could be internet/intranet which is wired or wireless. Item 400 is the Backend Server(s) environment that is normally employed by the business entities. Item 410 is the Backed process that handles business logic using the computer systems. Item 411 is a sign out or log out process that normally performed by the computer systems (servers) to terminate the user session. Item 414 is part of the OneClue Software system that collects the experience data and stores in the data store. Item 420 is a Data Store that business entities employ to store the data. Item 430 is the Analytical Engine that is part of the OneClue Software.

FIG. 2: Item 500 is the GUI (Graphical User Interface) for submitting online order. Item 500 is a pop up window that online customers use to place the order. It provides two options namely positive/good and negative/bad experience, where both of them will perform “submit order” action. Item 201 is the data packet containing order data and experience indicator. Item 412 is the order creation process that is executed on the computer systems/servers. Other items in the explained in [0005].

FIG. 3: Item 700 is the exit door of a physical store. Item 710 is a OneClue panel that contains, item 711 a digital camera that helps in creating fuzzy recognition data, item 712 a message/prompt about the shopping experience, item 713 is a button or area indicating happy/positive experience, item 714 is a button or area indicating unhappy/negative experience. Item 715 is customer hand, used to activate/press/click the items 713 & 714. Item 220 is a data packet containing fuzzy recognition data and experience indicator. Item 413 is the computer process that creates virtual transaction by associating cash register transaction, shopping path in the store, facial recognition data. It also obfuscates the actual identify to protect the customer privacy. Other items in the explained in [0005].

FIG. 4: Item 431 is a computer process that manages the analytical rules that configure and drive the OneClue Analytical Engine, item 410. Item 432 aggregates the transaction related data, visit related data. It uses the analytical rules which provides various thresholds (Min/Max), associations and exceptions (to the rules). Item 433 is a computer process that creates change log based on the time thresholds that are set as analytical rules. Item 434 is a computer process that creates mapping data using correlation rules that are set as analytical rules. Item 435 is a computer process that uses “Reduction by Elimination” algorithm, that reduces the problem space by ranking/relevance/expiration analytical rules in the engine.

### GENERAL DESCRIPTION OF EXEMPLARY EMBODIMENTS

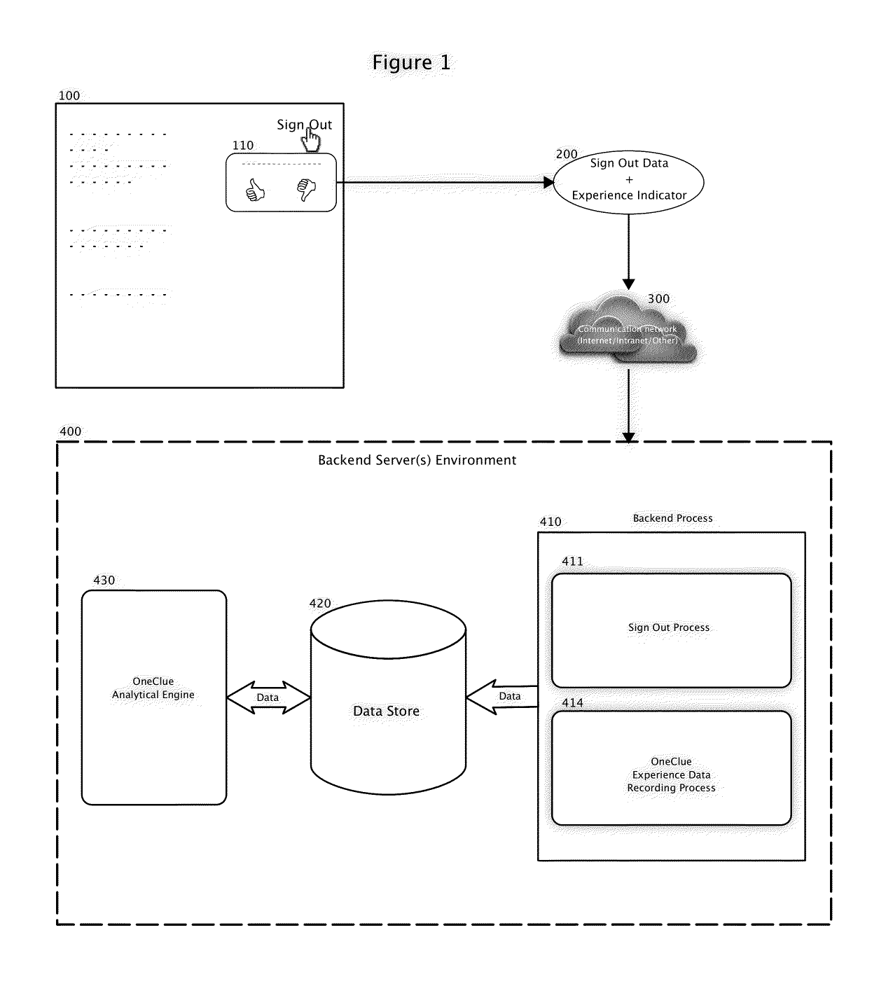

FIG. 1: In this figure, it is shown that customer(user) uses GUI screen (item 100) to sign out (log out). When customer (user) hovers/touches sign out area, a pop-up window (item 110) appears that will prompt user to click/touch one of the two options to perform sign out(log out) and express experience he/she had at the same time. Irrespective the option selected by the user out of the two options provided, it will perform sign out(log out) process and at the same time it will transmit experience indicator in the data packet (item 200) using internet/intranet (item 300). OneClue “Experience Data Recording Process” (item 414) will collect experience indicator, extract relevant user visit related data that is collected in the backend systems and store it in the data store (item 420). Depending the execution cycle set (event/time trigger), OneClue “Analytical Engine” (item 430) will process the data stored (item 420) to produce the customer experience report. Report produced by Analytical Engine will point to the areas that caused negative/positive responses by the customers. Alternatively, pop-up window (item 110) can be activated or deactivated by activation rules that are set in the system.

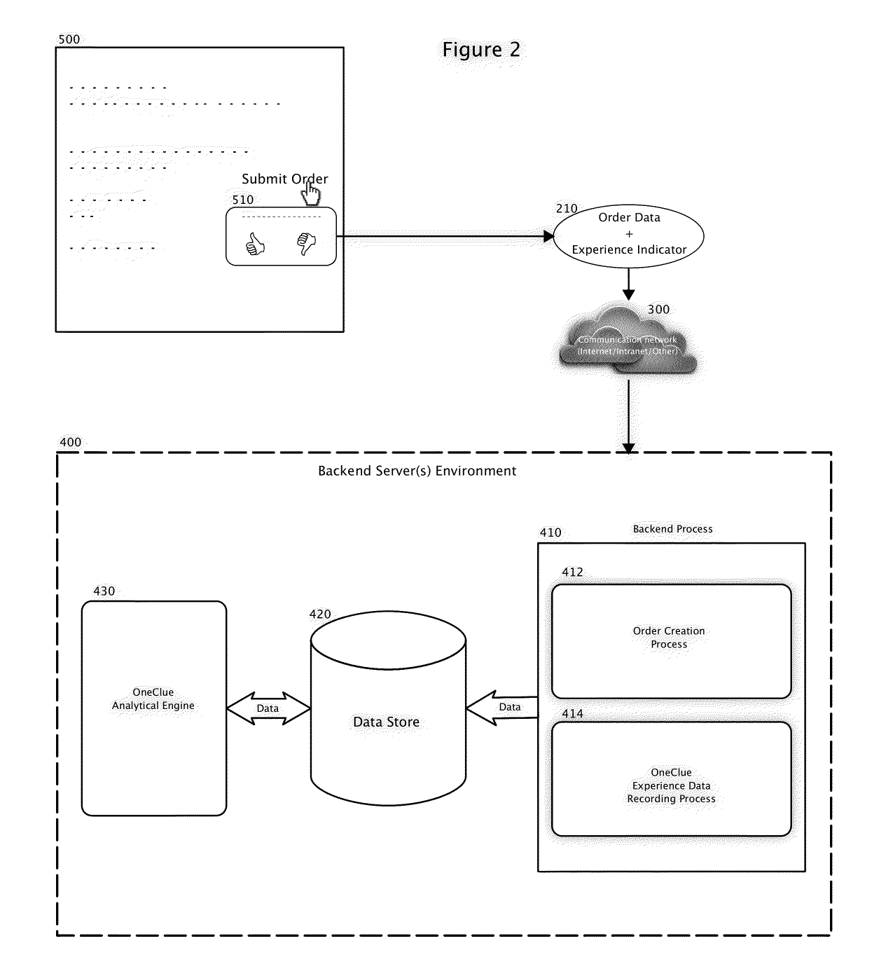

FIG. 2: Some online sites (or native computer applications) does not require the customer (user) to sign in(log in) to use or shop their online sites (item 500). When customer(user) hovers/touches “Submit Order” area (or any other prompt to place order), pop-up window (item 510) will prompt the user to select one of the two options. Both the options presented will invoke the action to transmit the order and the experience indicator in the data packet (item 210) using internet/intranet (item 300). Rest of the process is similar in backend environment (item 400) as explained in section except for order creation process (item 412). Alternatively, pop-up window (item 510) can be activated or deactivated by activation rules that are set in the system.

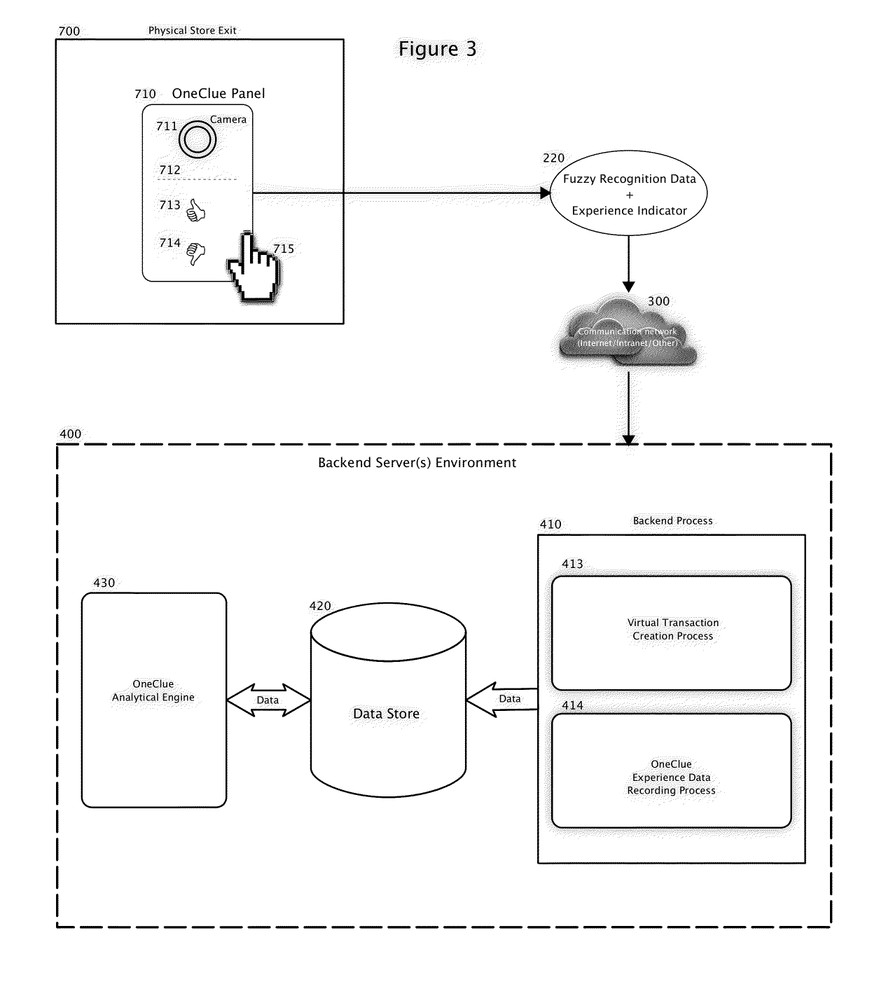

FIG. 3: This figure depicting the environment in the physical store exits (item 700). OneClue panel (item 710) is placed conveniently at the store exits that can be used by the customer to express experience he/she had during the current store visit using one of the two buttons (items 713 & 714). When he/she activates (by touching or pressing) buttons on the panel (items 713 or 714), digital camera takes facial picture. Fuzzy recognition data record is created and transmitted along with experience indicator as part of data packet (item 220). Using visit (areas of the store visited) related data and cash register transaction, a virtual transaction is created for further analysis purposes. Rest of the process is similar in backend environment (item 400) as explained in section [0009].

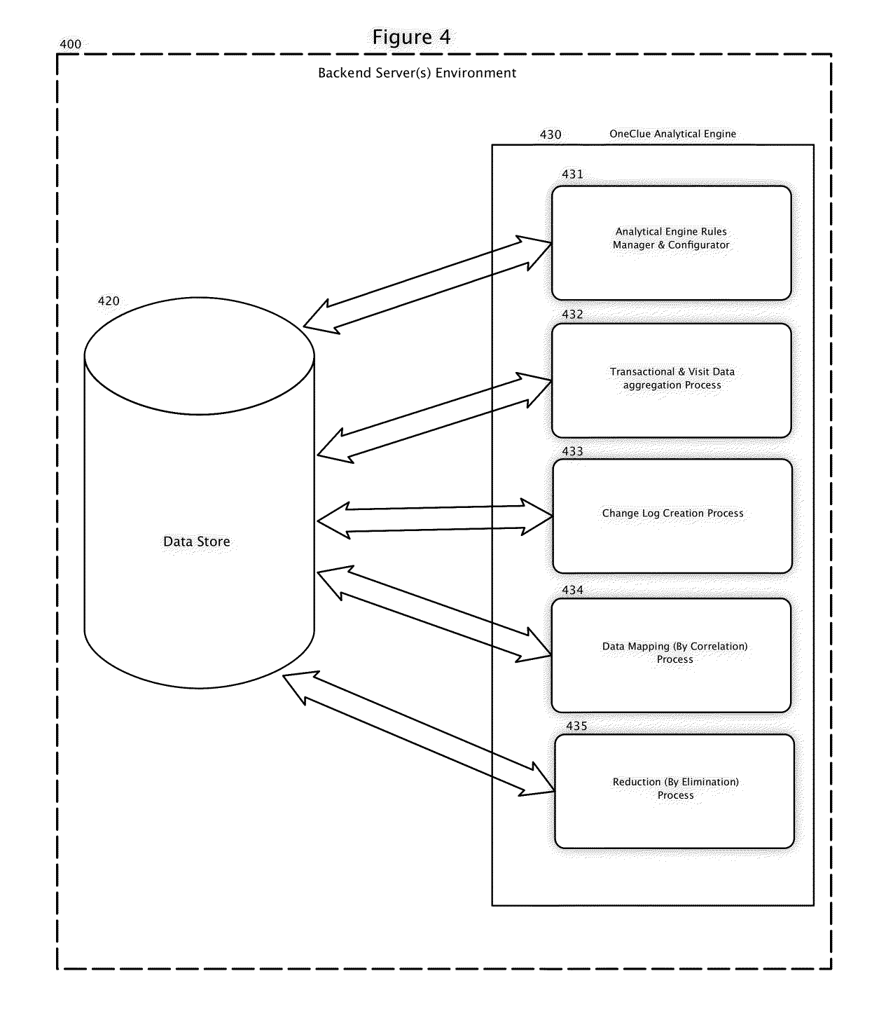

FIG. 4: This figure explains the OneClue Analytical Engine process (item 430). System threshold rules, event trigger rules, scope window rules, alert type rules, action rules, record type correlation rules, elimination rules, exception handling rules, change log creation rules are some of the types of rules that are managed in “Analytical Engine Rules Manager & Configurator” (item 431). Upon setting the sever threshold rule, system can generate high alert that will prompt immediate action from the executive levels. All the rules can be optimized over the period of time by the analyst (s). Aggregation process (item 432) uses scope window rules and collects transaction records, visit data records in the data store (item 420) and condenses to create a record set (Shopping patterns) that is used further. This can be instantaneous process depending the event trigger rules, to gain the process efficiency. Change log creation process (item 433) is a simple process that uses change log rules to create change record set that is used further. An example of that could be change to screen layout or a shelf placement. Using record correlation rules, mapping is performed by Data Mapping process (item 434) to create a record set that is used further in the analysis process. “Reduction by Elimination” (item 435) is a unique process that uses all the record sets created before and reduces to very high level summary report that could lead to actionable items if problem exists.

1. The process of capturing single clue about the customer(user) experience is unique, for online computer applications.

2. The process of capturing single clue about the customer(user) experience is unique, for physical stores.

3. The process of using facial picture and creating a fuzzy recognition data for identity is unique.

4. The process of creating virtual transactions for physical stores that depicts online shopping pattern is unique.

5. The process of using single clue, and reverse engineer to identify the problem areas using OneClue Analytical Engine Process (item 430) is unique.

6. The process of correlating the change(s) on the online site (application) or store, to customer (user) experience is unique.

7. The process of activating and deactivating customer experience pop-up window based on the activation rules is unique.

8. The process of creating and using change log (item 433) is unique.

9. The process of correlating shopping patterns (previous visits) to change log and shopping experience indicator (one clue), to determine the shopping experience problems is unique.

10. The process of “Reduction by Elimination”, to sift large amounts of data and arriving at concrete conclusions is unique.
